(19) United States
(12) Patent Application Publication
(10) Pub. No.: US 2015/0150119 A1
(43) Pub. Date: May 28, 2015

(54) FRAMEWORK FOR FINE-GRAIN ACCESS CONTROL FROM HIGH-LEVEL APPLICATION PERMISSIONS

(71) Applicant: GM GLOBAL TECHNOLOGY OPERATIONS LLC, DETROIT, MI (US)

(72) Inventors: GAVIN D. HOLLAND, OAK PARK, CA (US); KARIM EL DEFRAWY, SANTA MONICA, CA (US); ALEKSEY NOGIN, FRESNO, CA (US)

(21) Appl. No.: 14/518,020

(22) Filed: Oct. 20, 2014

Related U.S. Application Data
(60) Provisional application No. 61/909,451, filed on Nov. 27, 2013.

(51) Int. Cl. G06F 21/60

(52) U.S. Cl. CPC G06F 21/604
USPC 726/17

(57) ABSTRACT

A method for access control of an application feature to resources on a mobile computing device. An application is prepared for installation on the mobile computing device via a processor. An application permission associated with the application is identified. The application permission relates to access of resources of the mobile computing device. Restrictions associated with the application permission are determined. A set of mandatory access control rules are defined for the application permission based on the restrictions. The set of mandatory access control rules and the application permission are combined in a loadable mandatory access control policy module. The loadable mandatory access control policy module is stored in a memory of the mobile computing device, the loadable mandatory access control policy module capable of being enforced by an operating system of the mobile computing device.

### CROSS-REFERENCE TO RELATED APPLICATIONS

This application claims priority of U.S. Provisional Application Ser. No. 61/909,451 filed Nov. 27, 2013, the disclosure of which is incorporated by reference.

### BACKGROUND OF INVENTION

An embodiment relates generally to mobile computing devices.

Operating system platforms for mobile computing devices enable the users of such devices to download application programs to their mobile computing devices.

A central design point of the operating system platforms is the security architecture. By default, no application has the permission to perform any operation that would adversely affect other applications or the operating system. Such applications being executed off the same platform of the mobile computing device share resources and data. This is performed by declaring permissions that are needed for execution of the application, but may not be initially allowed by the operating system. As a result, when users of the mobile computing device are downloading a respective application to their mobile computing device, the users are prompted by the operation system as to which permissions will be allowed to execute the application. The user is prompted for consent at the time the application is installed. Such systems have no mechanism for granting permissions at the time the application is executed. Once the user accepts the permission at the high level application permissions, there is no security check for malicious applications that once installed find ways around the operating system to obtain access to system's resources that should be off-limits to the application when launched.

### SUMMARY OF INVENTION

An advantage of an embodiment is the mapping of high-level application permissions to low-level mandatory access control (MAC) policies. High-level application permissions, declared in a file that is part of an application's package and often presented to the user for subsequent approval prior to installation, have been recently adopted on a large class of mobile devised utilizing the operating system platform. The embodiments described herein are applicable to a wide variety of platforms for generating finer-granularity policies based on the permissions requested in a permission file, confining each application's access to resources, hardening the overall system, and improving security.

In an embodiment of the invention contemplates a method is provided for access control of an application feature to resources on a mobile computing device. An application is prepared for installation on the mobile computing device via a processor. An application permission associated with the application is identified. The application permission relates to access of resources of the mobile computing device. Restrictions associated with the application permission are determined. A set of mandatory access control rules are defined for the application permission based on the restrictions. The set of mandatory access control rules and the application permission are combined in a loadable mandatory access control policy module. The loadable mandatory access control policy is stored in a memory of the mobile computing device. The loadable mandatory access control policy module capable of being enforced by an operating system of the mobile computing device.

A method for installing access control on a mobile computing device. A communication is established between a mobile computing device and an application distribution entity. The application distribution entity configured to transmit an application to the mobile computing device upon a request by the mobile computing device. A request is sent by the mobile computing device to the application entity for downloading the application. Application permissions associated with the application are identified, the application permission relating to access resources of the mobile computing device. Restrictions associated with the application permission are determined. A set of mandatory access control rules are defined for the application permission. The set of mandatory access control rules and the application permission are combined in a loadable mandatory access control policy module.

### BRIEF DESCRIPTION OF DRAWINGS

FIG. 1 is a pictorial illustration of a mobile computing device.

FIG. 2 is a pictorial illustration of a mobile computing device displaying high-level permissions.

FIG. 3 is a block diagram illustration of the communicating devices.

FIG. 4 is an exemplary block diagram of the interaction between application distributor and a mobile computing device.

FIG. 5 is a block diagram for installing an application on a generic platform with MAC capability.

FIG. 6 is an illustration of exemplary sample application permissions.

FIG. 7 is an illustration of an exemplary manifest file.

FIG. 8 is an illustration of a loadable policy module.

### DETAILED DESCRIPTION

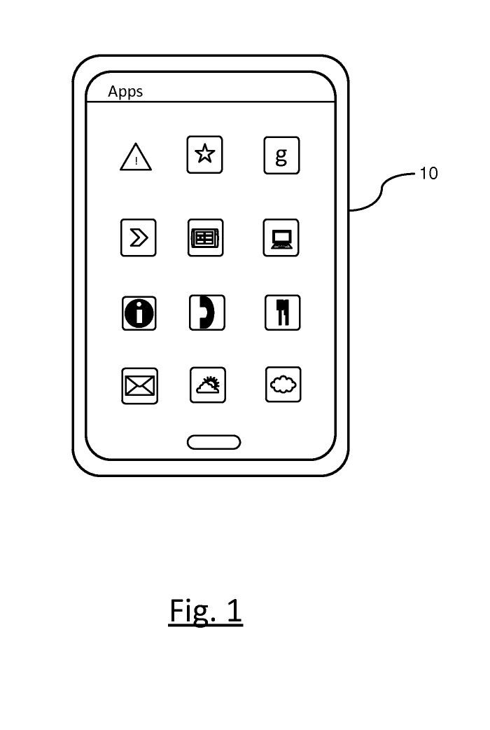

FIG. 1 illustrates a mobile device 10 including, but not limited to, a smart phone, carried by a user which is used as a multi-function computing and telephony device. The mobile device 10 utilizes a mobile operating system platform and advanced application programming interfaces (APIs) for running mobile applications. A mobile application is a software application designed to run on various types of mobile computing devices. These applications are available through application distribution platforms. Mobile applications are either free or must be purchased. Such applications are downloaded from the operating system platform to the mobile device. Due to the versatility of running various applications on the mobile device that are typically run on a computer, the variety and the number of applications that can be downloaded to the mobile device are ever increasing.

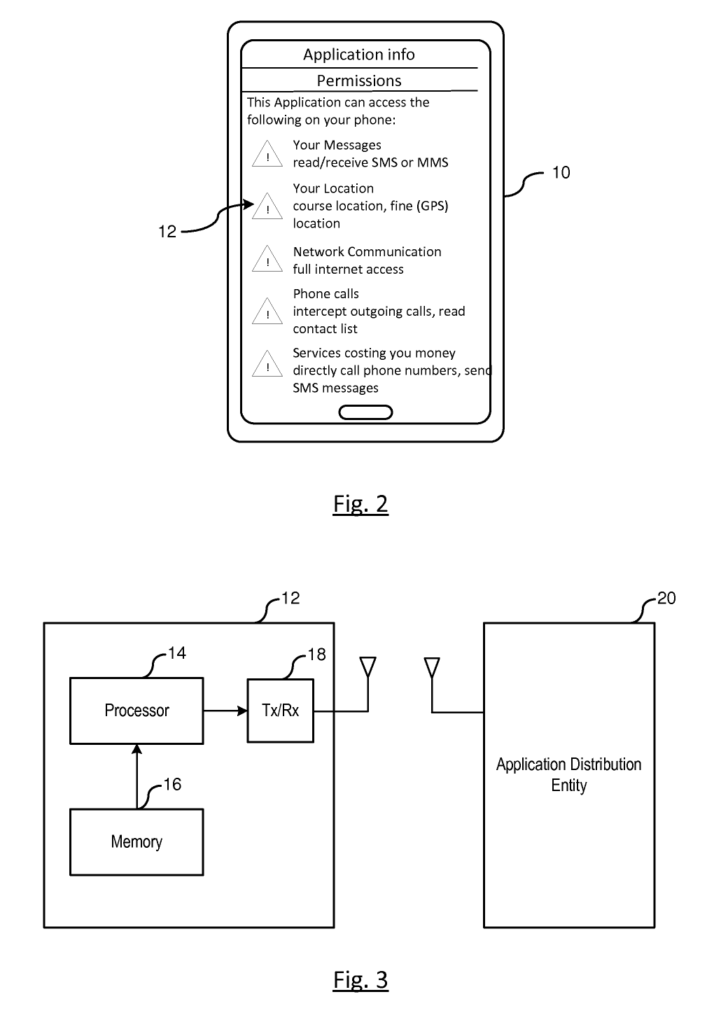

When an application is downloaded to a mobile computing device, the user is prompted with one or more high-level permissions that the user must agree to in order to complete installation of the application. Permissions are security features are mechanisms that enforce restrictions on the specific resources or operations of the mobile computing device that a particular process can perform. An example of permissions is shown in FIG. 2. The permissions 12 shown are only a few of a plurality of permissions that may be requested for access by the application when the application is launched or is in use. Such high level permissions include, but are not limited to, read/receive SMS or MMS, course location/fin (GPS) location, full internet access, intercepting outgoing calls, reading contact list, dialing permissions, text access permissions, and address book information. The user must concur with the permission request; otherwise, the application will not be stored on the mobile device 10.

Once the application is loaded and whenever the application is attempted to be launched, authorization rules are attempted to be enforced by the operating system for determining whether access can take place. However, not all applications installed can be trusted. For example, some applications could be developed by untrusted parties and may contain malicious code that once installed, may have algorithms to go behind the security operations performed by the operating system, or some applications may have potential security flaws of which security risks must be minimized. Therefore, the following technique describes a framework that allows the development and use of low-level mandatory access control (MAC) policies for strengthening security so that only those specific permission granted authorization are granted access. The process operates by mapping the high-level authorized permissions to low-level MAC policies. MAC refers to a type of access control by which the operating system constrains the ability of a subject to access/perform some type of operation on an object or target. In general, a subject relates to a process or thread, whereas objects are constructs such as files, directories, TCP/UDP ports, shared memory segments, etc. Subjects and objects both have a set of security attributes. When a subject attempts to access an object, an authorization rule, enforced by the operating system kernel, examines the security attributes and makes the necessary determination of whether access can be granted. Any operation by a subject on an object will be tested against the set of authorization rules (hereinafter referred to as a MAC policy) to determine if the operation is allowed.

FIG. 3 illustrates a block diagram of the hardware devices utilized herein. The mobile device 10 includes one or more processors 14, memory 16, and a transmitter and receiver 18 or may be combined as a transceiver. An application distributor 20 is an owner or distributor of an application requested by the mobile device 10. The application distributor 20 upon request by the mobile device 10 distributes an application to the mobile device for storage and use on the mobile device 10. The application may be communicated wirelessly or by wireline between the application distributor 20 and the mobile device 10. The application is stored in a memory 16 of the mobile device and is executed via the processor 16. It should be understood that the processor may be the primary processor of the mobile device, or a standalone processor.

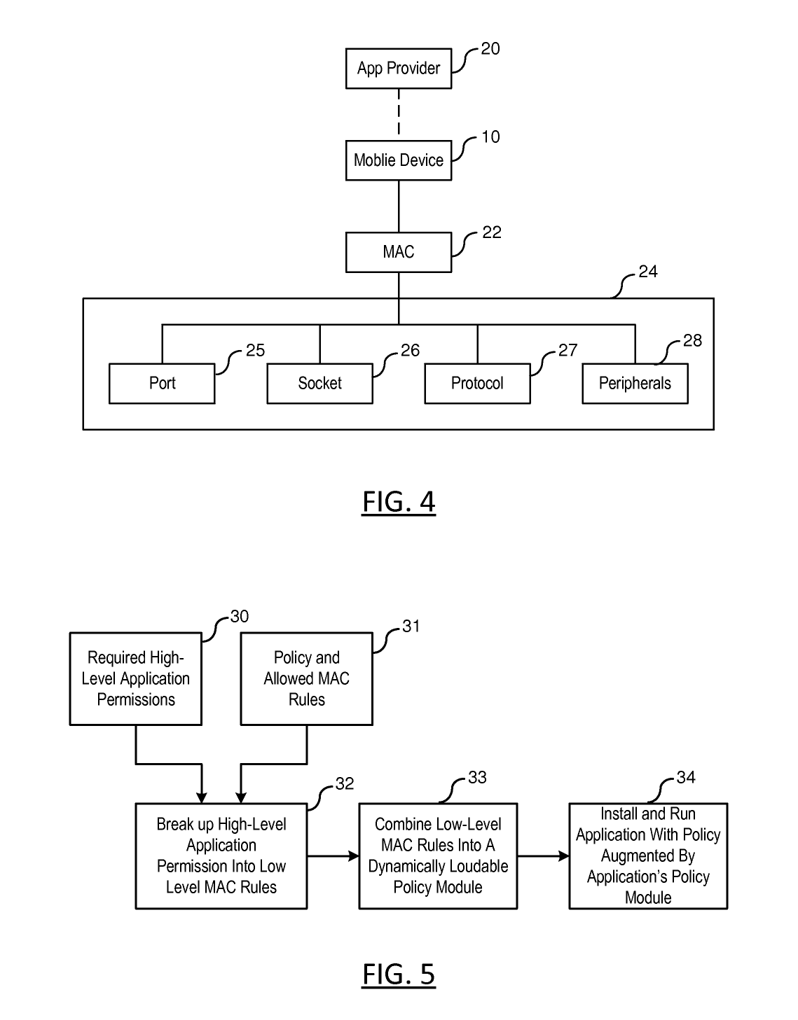

FIG. 4 illustrates an exemplary block diagram of the interaction for requesting access to recourses on the mobile computing device. The mobile computing device includes a mandatory access control policy 22 that sets forth authorization rules that are used to determine if access can be gained to resources 24 of the mobile computing device 10. Resources include but are not limited to communication ports 25, sockets 26, protocols 27, and peripherals 28 (e.g., cameras, contact lists, etc). It should be understood that the above mentioned resources are only a small fraction of the available resources that available on the mobile computing device 10.

The high-level application permissions that are declared in a file that are part of an application's package and presented to the user for subsequent approval prior to installation of the application generates finer-granularity policies based on the permissions requested in these permission files, thereby confining each application's access to resources, hardening the overall system, and improving its security. This approach further restricts an application's access to the system's resources (e.g., files, network sockets, peripherals, camera, user contacts and data), well beyond that of traditional permission access model, by extending it to use a MAC policy.

The embodiments described herein are for mapping the application permissions to MAC, which results in a significant reduction in the size of the trusted code base. Compared to approaches that operate directly at the MAC policy level, this technique provides the advantage of being able to formulate and manage policies at the application permission level, where the permissions are easier to manage, and enforcing the permissions at a much lower MAC level where the permissions can be more securely enforced. Without this technique described herein, it is only possible to execute one or the other, but not both.

A block diagram for installing an application on a generic platform with any MAC capability is shown in FIG. 5. In block 30, high level application permissions that are required for the application are identified. In block 31, an existing operating system policy, such as Security-Enhanced Linux (SELinux), and a file containing the allowed MAC rules are obtained. SELinux is a Linux feature that provides the mechanism for supporting access control security policies through the use of Linux Security Modules (LSM) in the Linux kernel. Its architecture strives to separate enforcement of security decisions from the security policy itself and streamlines the volume of software charged with security policy enforcement. The obtaining of the MAC rules and the SELinux is performed offline priori. A mapping between high-level application permissions and the corresponding low level MAC rules must be applied. That is, for each high-level permission identified by the platform operating system, an associated predetermined mapping is identified relating to MAC rules for the respective permission utilizing a processor. A manifest file is provided that maps the high level permission to a SELinux MAC rule identifying what privileges the permission has, which will be enforced at the MAC level. It should be understood that the specific technique of how mapping is determined is not described herein and that the invention may utilize any mapping technique that is constructed manually or autonomously determining which MAC rules will be mapped to a permission.

In block 32, the high level application permissions are broken down into low-level MAC rules during on-line processing. A software mechanism scans a file that contains permissions that the application is requesting (e.g., permissions section in the manifest file). The system via the processor converts each permission in the file to its corresponding MAC rule with the required details (e.g., whether a socket TCP or UDP socket in the case of internet permission). Therefore, MAC rules for defining what the specific permissions relating to communications, ports, devices, and other access details is identified for each permission. This step may require enforcing the appropriate MAC labeling of the processes and/or applications, on which the new rules are to be imposed. This step may also require analysis of the application source code, if provided, or analysis of the binary code if no source code is provided. As an option, high-level permissions language could further be extended to give additional information in the requested permissions that would help the process of mapping them to the MAC rules.

In regards to an application, if little information is known about the application, then a general set of MAC rules may be utilized for a respective permission. That is, the less that is known about an application (e.g., more possibility that it may be from an untrusted source or have the potential to be malicious), then the more constraints that are applied to the permission at the MAC level. If more information is known about the application, such that it is trusted and it is readily understood that accessing information is being used for legitimate reasons, then the permissions may be more broadly granted thereby allowing more freedom for accessing certain features or operations. Having knowledge of an application may be performed manually by a programmer generating the manifest file, or may be performed autonomously through software using other mapping techniques.

In block 33, the low level MAC rule is combined into a dynamically loadable policy module. An example is a mapping of an internet high-level permission in the manifest.xml file to a respective SELinux MAC rule identifies that the application may create a socket and specifies (in the MAC rule) which type of SCKET, TCP or UDP, and the allowed port that may be used. Each one of the high-level permissions are translated to low level MAC rules, and each of the translated permissions are bundled into one loadable policy module (e.g., a SELinux policy module that can be enabled in the SELinux policy when the application is executed).

In step 34, the application is installed along with the loadable policy module. Each time the application is run, the application is executed with the policy augmented by the application's policy module at the MAC level.

To identify what the permissions are for each application (e.g., Android™), each has a manifest file (e.g., AndroidManifest.xml) in its root directory. The manifest provides essential information about the application to the operating system platform. This information must be received by the operating system platform before the application can run any of the application's code. The manifest typically includes the following: (1) the manifest file names the Java package for the application where the package name serves as a unique identifier for the application; (2) the manifest file describes components of the application, for example, the activities, services, broadcast receivers, and content providers, that the application is composed of. The manifest file also names the classes that implement each of the components and publishes their capabilities (e.g., which internet messages they can handle). Such declarations allow the operating system platform to know what the components are and under what conditions they can be launched; (3) the manifest file determines which processes will host application components; (4) the manifest file declares which permissions the application must have to access protected parts of the API and interact with other applications; (5) the manifest file declares the permissions that other applications are required to have to interact with the application's components; (6) the manifest file lists instrumentation classes that provide profiling and other information as the application is running (such declarations may only be present in the manifest while the application is being developed and tested and are removed before the application is published); (7) the manifest file declares the minimum level of the Android API that the application requires; (8) the manifest file lists the libraries that the application must be linked against.

A permission is a restriction limiting access to a part of the code or to data on the device. This limitation is imposed to protect critical data and code that could be misused to distort or damage the user experience.

Each permission is identified by a unique label. The label often indicates the action that is restricted. The following are examples of permissions (e.g., permissions for Android):

android.permission.CALL_EMERGENCY_NUMBERS
android.permission.READ_OWNER_DATA
android.permission.SET_WALLPAPER
android.permission.INTERNET

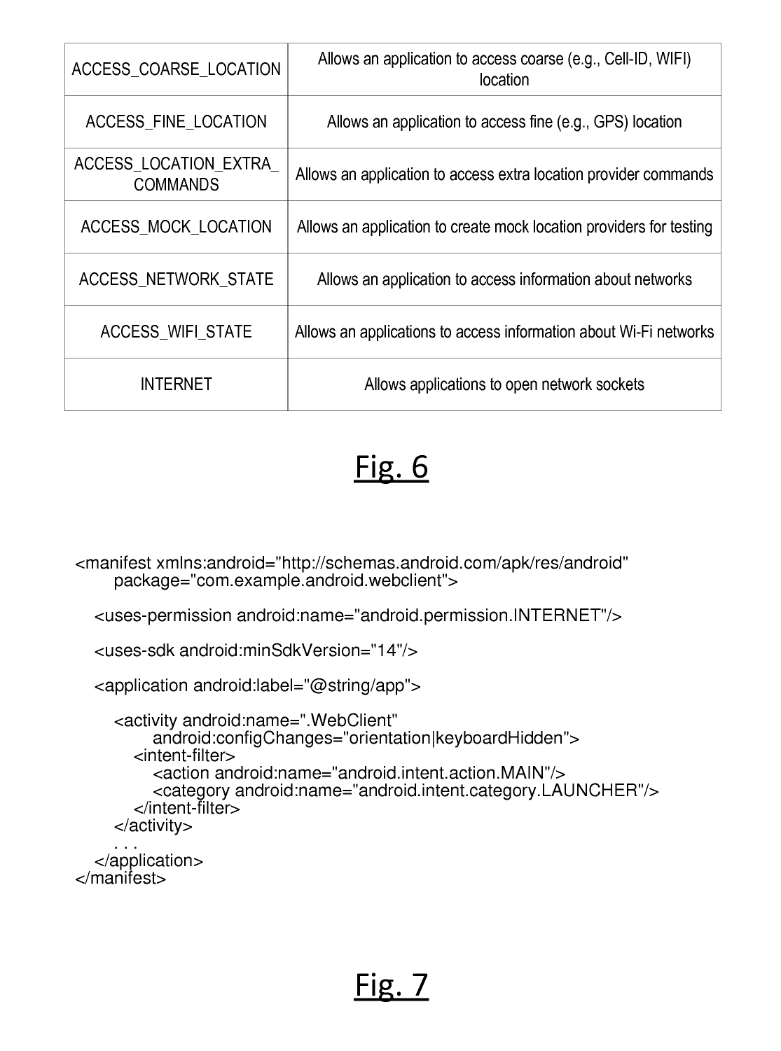

Moreover, FIG. 6 illustrates sample application permissions and their associated access functions that can be requested in a manifest file.

A feature can be protected by at most one permission. If an application needs access to a feature protected by a permission, then the application must declare that it requires that permission with a <uses-permission> element in the manifest. Upon installation of the application on the mobile device, a user determines whether or not to grant the requested permission by checking the authorities that signed the application's certificates, and in some cases, asking the user. If the permission is granted by the user, then the application is able to use the protected features. If the permission is not granted, then an attempt to access those features will simply fail without any notification to the user.

An application can also protect its own components (activities, services, broadcast receivers, and content providers) with permissions. It can employ any of the permissions defined by the operating system platform listed in manifest permission file as declared by other applications or the application can define its own. A new permission is declared with the <permission> element. An example of an activity that can be protected is as follows:

<manifest . . . >

<permission android:name=“com.example.project.DEBIT_ACCT” . . . />
<uses-permission android:name=“com.example.project.DEBIT_ACCT” />

. . .

<application . . .>

<activity android:name=“com.example.project.FreneticActivity”

android:permission=“com.example.project.DEBIT_ACCT”
. . . >

. . .

</activity>

</application>

</manifest>

In the above example, a DEBIT_ACCT permission is shown. The DEBIT_ACCT permission is not only declared with the <permission> element, its use is also requested with the <uses-permission> element. Its use must be requested for other components of the application to launch the protected activity, even though the protection is imposed by the application itself.

In the above example, if the permission attribute was set to a permission declared elsewhere (e.g., Android.permisssion.CALL.EMERGENCY_NUMBERS), it would not have been necessary to declare it again with a <permission> element. However, it would still have been necessary to request its use with <uses-permission>.

A <permission-tree> element declares a namespace for a group of permissions that will be defined in the code. A <permission-group> defines a label for a set of permissions, both those permissions declared in the manifest with <permission> elements and those declared elsewhere. This affects only how the permissions are grouped when presented to the user. The <permission-group> element does not specify which permissions belong to the group; it just gives the group a name. A respective permission is placed in the group by assigning the group name to the <permission> element's “permissionGroup” attribute.

Once all high-level permissions are translated to low level MAC rules, they are all bundled into one loadable policy module and SELinux Policy module that can be enabled in the SELinux policy when application is executed.

The following is an example of how high level permissions can be mapped to corresponding low level MAC rules. The example involves an “internet” high-level permission in an application's manifest file and shows how it can be mapped to a set of SELinux MAC rules that allows the application to create a network socket, but restricts the application to only a specific type of socket and port.

The excerpt is an exemplary manifest file for the notional web-client application that requires the INTERNET permission is shown in FIG. 7. Utilizing Android permissions as an example, the application is a web client that requests the android.permission.INTERNET permission with a <uses-permission> element in the manifest.

The SELinux MAC rules are mapped to the INTERNET permission for more fine-grained access control. This performed by showing how the application is defined within the SELinux policy language.

type user_webclient_t, domain, application_domain_type;
role user_r types user_webclient_t;

The first line defines a new type (domain) for the webclient, user_webclient_t, which is assigned the same access attributes as the more general class domain and the more general type application_domain_type. These are common attributes that are used on a wide variety of applications. The second line assigns a “role” to the application that is standard for most user-mode applications, user_r, and defines a further set of common restrictions.

Next, the application's use of the network is constrained as follows.

type http_port_t, port_type, reserved_port_type;
allow user_webclient_t self:tcp_socket { create { ioctl read getattr write

setattr append bind connect getopt setopt shutdown } };

allow user_webclient_t http_port_t:tcp_socket { send_msg recv_msg

name_connect};

While the first line allows the application to create and manipulate a TCP network socket, the second line allows it to bind to, send, and receive packets on one of a designated HTTP ports. This is defined by http_port_t. The first line defines the HTTP port type http_port_t, which has the same attributes as the more general port_type and reserved_port_type. The tcp_socket class defines the operations allowed on a TCP socket.

The following are specific port numbers that are controlled by the http_port_t and are defined as follows:

portcon tcp 80 system_u:object_r:http_port_t
portcon tcp 443 system_u:object_r:http_port_t
portcon tcp 488 system_u:object_r:http_port_t
portcon tcp 8008 system_u:object_r:http_port_t
portcon tcp 8009 system_u:object_r:http_port_t
portcon tcp 8443 system_u:object_r:http_port_t

Each line assigns a security context for the TCP protocol for one of the common port numbers associated with the HTTP protocol. The net result is that the webclient application is constrained to bind only to a TCP socket on a port associated with the HTTP protocol.

In addition, it can be illustrated how SELinux rules can be used to control the application's use of the network further, but constraining its ability to send and receive any packets other than those marked as HTTP packets.
type http_client_packet_t, packet_type, client_packet_type;

As shown above, the HTTP packets are labeled in the SELinux policy as having the same attributes as the more general packet_type and client_packet_type. The rule constraining the application's use of such packets is as follows:
allow user_webclient_t http_client_packet_t:packet {send recv};

As shown in the rule, the application is constrained to only send and receive packets that have been marked as belonging to the identified HTTP protocol.

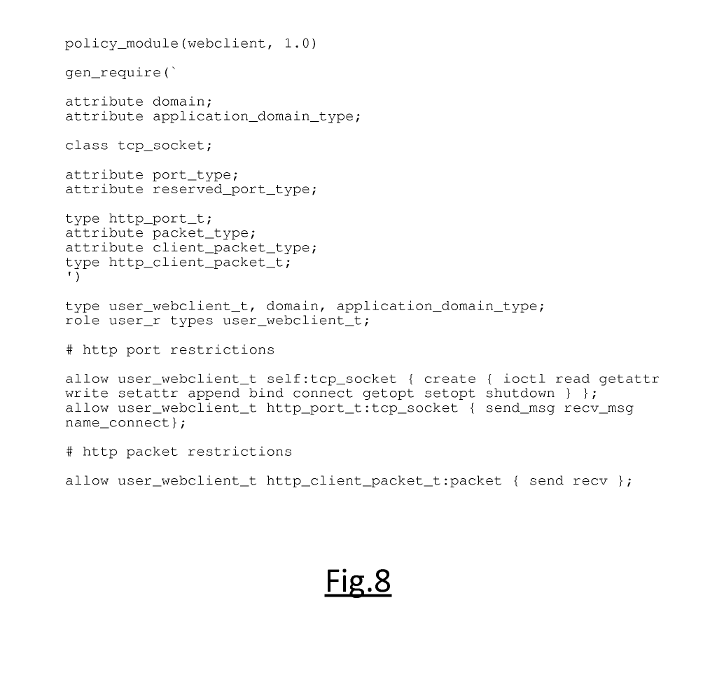

Finally, the rules are combined into a loadable policy module, which is shown in FIG. 8. The module is first named (webclient), and the definitions that are required to be defined elsewhere are listed (gen_require), followed by a set of definitions and rules specific to the webclient application.

The framework as described herein can also realize a sandboxing environment for various applications that are installed, but not trusted. In a sandboxing environment, the application will be installed and given the high-level permissions requests using the low-level MAC rules. The requested permissions will be highly restricted to make sure that they do not perform any malicious operations. For example, an application may request internet connectivity and access to private information stored on a phone, but the nature of the application does not justify transmission of private information off the phone and over a network. Therefore, a MAC rule can be added to the policy module to be installed on the operating system alongside the application, which prevents the application from reading any sensitive data (e.g., contacts stored on phone, location information) and initiating outbound network connections.

However, when imposing such constraints, there is the potential that the application may not function correctly even if it has legitimate reasons for executing both restricted activities. A further embodiment may be implemented, hereinafter referred to as a “sandbox agent” that interacts with the application and functions as a proxy between the application and its outside environment. MAC rules can then be implemented that will allow only outbound traffic from the suspicious application to the sandbox agent. The discretion resides with the sandbox agent to determine which outbound traffic to forward and which to block, thereby effectively sandboxing the suspicious application.

While certain embodiments of the present invention have been described in detail, those familiar with the art to which this invention relates will recognize various alternative designs and embodiments for practicing the invention as defined by the following claims.

What is claimed is:

1. A method for access control of an application feature to resources on a mobile computing device comprising the steps of:
preparing an application for installation on the mobile computing device via a processor;
identifying an application permission associated with the application, the application permission relating to access of resources of the mobile computing device;
determining restrictions associated with the application permission;
defining a set of mandatory access control rules for the application permission based on the restrictions;
combining the set of mandatory access control rules and the application permission in a loadable mandatory access control policy module; and
storing the loadable mandatory access control policy module in a memory of the mobile computing device, the loadable mandatory access control policy module capable of being enforced by an operating system of the mobile computing device.

2. The method of claim 1 wherein a manifest file maps the application permission to the set of mandatory access control rules.

3. The method of claim 2 wherein the manifest file enumerates the application permission requested by the application.

4. The method of claim 3 wherein the permission in the manifest file is mapped to the set of mandatory access control rules providing authorization rules for accessing the mobile computing device resources.

5. The method of claim 4 wherein the mandatory access control rules define access to a respective socket.

6. The method of claim 5 wherein the mandatory access control rules define an operation allowed on the respective socket.

7. The method of claim 4 wherein the mandatory access control rules define access to a respective port.

8. The method of claim 7 wherein the mandatory access control rules define sending capabilities through the respective port.

9. The method of claim 7 wherein the mandatory access control rules define receiving capabilities through the respective port.

10. The method of claim 1 wherein the mandatory access control rules are generated as SELinux mandatory access control rules.

11. The method of claim 1 wherein the policy module is generated as a SELinux policy.

12. The method of claim 1 wherein the policy module, mandatory access control rules, and the mapping are obtained as inputs during offline processing.

13. The method of claim 1 wherein during online processing, a processor scans a manifest file containing the permission that the application is requesting.

14. The method of claim 1 wherein a processor converts the permission in the file to the set of mandatory access control rules.

15. The method of claim 1 wherein the loadable policy module is generated as a SELinux policy module.

16. The method of claim 1 wherein a sandboxing framework is utilized for preventing the application from accessing resources of the mobile computing device, wherein the sandbox framework functions as a proxy between the requesting application and the device resources.

17. The method of claim 16 wherein the proxy provides access to a virtual copy of a system file of the mobile device, wherein selective access is only allowed to the virtual copy of the system file thereby preventing access to the system file of the mobile device.

18. The method of claim 16 wherein the sandbox framework functions as the proxy between the requesting application and an operating system controlling the resource.

19. The method of claim 16 wherein the sandbox enforces the mandatory access control policy module.

20. A method for installing access control on a mobile computing device comprising:
establishing a communication between a mobile computing device and an application distribution entity, the application distribution entity configured to transmit an application to the mobile computing device upon a request by the mobile computing device;
sending a request by the mobile computing device to the application entity for downloading the application;
identifying application permissions associated with the application, the application permission relating to access resources of the mobile computing device;
determining restrictions associated with the application permission;
defining a set of mandatory access control rules for the application permission; and
combining the set of mandatory access control rules and the application permission in a loadable mandatory access control policy module.

21. The method of claim 20 wherein a sandboxing framework is utilized for preventing the application from accessing resources of the mobile computing device, wherein the sandbox framework functions as a proxy between the requesting application and the device resources, wherein the proxy provides access to virtual copies of resources of the mobile device, wherein access is only allowed to the virtual copy of the resources thereby preventing access to the resources of the mobile device.

22. The method of claim 20 wherein the application feature is granted access during enablement of the application if authorized by the mandatory access control rules associated with the permission.
